(19) United States
(12) Patent Application Publication
(10) Pub. No.: US 2011/0196694 A1
(43) Pub. Date: Aug. 11, 2011

(54) Method And Arrangement For Producing Medical Reports

(75) Inventors: Karlheinz Dorn, Kalchreuth (DE); Subrata Sinha, Erlangen (DE); Vladyslav Ukis, Nuernberg (DE)

(73) Assignee: SIEMENS AKTIENGESELLSCHAFT, Munich (DE)

(21) Appl. No.: 12/986,267

(22) Filed: Jan. 7, 2011

(30) Foreign Application Priority Data
Feb. 9, 2010 (DE) 10 2010 007 333.4

(51) Int. Cl. G06Q 50/00; G06Q 10/00

(52) U.S. Cl. 705/2

(57) ABSTRACT

A method and an associated arrangement are disclosed for producing medical reports. The method is embodied in a medical data management system. in t least one embodiment, provision is made here for storing cross-reference data which cross-refers to object data that is obtained by way of various medical applications. The cross-reference data is used when producing medical reports, in order to include the associated object data, which is identified by the cross-reference data, in the report. in at least one embodiment, this results in an advantageous time saving when producing a medical report which can be considerable, particularly in the context of complex series of examinations involving various medical applications.

### PRIORITY STATEMENT

The present application hereby claims priority under 35 U.S.C. §119 on German patent application number DE 10 2010 007 333.4 filed Feb. 9, 2010, the entire contents of which are hereby incorporated herein by reference.

### FIELD

At least one embodiment of the present invention generally relates to a method and/or an associated arrangement for producing medical reports.

### BACKGROUND

Current practice when producing reports in the medical environment is for a medical examination to conclude with the production of a corresponding electronic report by a doctor. The report is usually produced using a software application which has been specially configured for this purpose and which, during the examination, accepts artifacts that have been produced as inputs, such as e.g. image sections, markings or distance lines between two points etc.

In the clinical environment today, it is necessary to produce increasingly complex reports which are based on inputs from a plurality of highly specialized specific medical applications. In the context of such reports, the doctor must be able to switch into the relevant medical application if necessary during production of the report, in order to use dedicated tools to view the artifacts that the medical application contributes to the report.

Report generator applications today allow medical reports to be produced on the basis of object data having a defined data format (usually DICOM: Digital Imaging and Communications in Medicine), the object data then being stored in an object data archive (usually PACS: Picture Archiving and Communication System). In this case, the procedure is as follows:

A doctor uses a viewing application to perform an evaluation.

When the evaluation is complete, object data that is relevant to the medical report is produced by the medical application and sent to an object data archive.

At a subsequent point in time, a (possibly different) doctor produces a medical report relating to the examination that was performed.

A report generator application fetches the required object data from the object data archive. If the doctor needs to look at the object data using the original medical application, because specific tools for this purpose are only available there, said doctor must start the medical application, select corresponding layouts and load the objects.

The doctor switches back to the report generator application and produces the medical report using the means that are provided for this purpose.

With reference to this procedure, it is clear that report generator applications today neglect the crucially important aspect for the doctor of linking back from the report generator applications to the viewing applications. The doctor must therefore personally start the relevant medical application, find the corresponding object data, select layouts, load object data and look at it. This process must be repeated for every artifact and every medical application, such that considerable time is required to produce complex medical reports. The repeated manual switching between the report generator applications and the viewing applications significantly increases the time that is required to produce reports.

DE 102005005601 B4 discloses an access control to medical object data, allowing text-based findings and specific graphic measuring results that substantiate these findings to be associated in a simple and reliable manner. However, the doctor must switch into the relevant underlying medical application during production of the report when required, if the graphic measuring result has to be analyzed using specific tools.

### SUMMARY

In at least one embodiment of the invention, an improved method and/or an arrangement for producing medical reports is specified.

In at least one embodiment of the invention, a method and/or an arrangement for producing medical reports is disclosed.

Advantageous developments of the invention are derived from the subclaims.

At least one embodiment is directed to a method for producing medical reports, the method being embodied in a medical data management system. In this case, provision is made for storing cross-reference data which cross-refers to object data that is obtained by way of various medical applications. Such object data can be e.g. image sections, markings or distance lines, which were created by a doctor during the evaluation of data material, e.g. a CT recording. The object data is also frequently referred to as findings. It comes from different medical applications (so-called tasks) such as, for example, image data display applications for a computer tomograph, magnetic resonance tomograph, positron emission tomograph, etc.

By storing a cross-reference data record, a cross-reference is created which points to the object data that was obtained using a medical application. It is therefore possible to reference object data from different medical applications via its cross-reference data. The cross-reference data is then used during the production of medical reports for the purpose of including the associated objects, to which the cross-reference data points, in the report. By virtue of this procedure, the different medical applications are, so to speak, interactively included in the production of the medical report. Manually switching into the relevant medical application, in order that the desired object data can be searched for, selected and transferred into the medical report, is therefore unnecessary. This results in an advantageous time saving when producing a medical report which can be considerable in some circumstances, particularly in the context of complex series of examinations involving various medical applications.

In one embodiment of the invention, the object data is stored in the medical management system with the aid of the cross-reference data. For example, therefore, e.g. a snapshot image for each individual finding can be stored directly in the medical management system, and then displayed by default for this finding. Switching into the medical application by means of which the finding was originally obtained is then only necessary if the standard view of the finding is not adequate and, for example, the finding must be edited for the medical report that is to be produced. This advantageously results in faster inclusion of the finding, since the snapshot image of the finding will often satisfy the requirements of the doctor.

Furthermore, the object data can be directly displayed in the medical applications (from which it was obtained) before production of the medical reports. This has the advantage that it is then possible to edit the object data directly in the original medical applications and e.g. use tools that are only available there.

In an example embodiment, the object data can be displayed with the aid of its cross-reference data before production of the medical reports. It is therefore possible to navigate through the findings that have been created, and to view them before their inclusion in the medical report. This takes place without having to switch between the individual medical applications in a time-consuming manner.

Furthermore, the cross-reference data can be stored in a patient-oriented manner. This advantageously satisfies the requirement for patient-oriented production of the medical reports.

In a further embodiment of the invention, the cross-reference data can be accessed by a plurality of users, either simultaneously or at different times. This means that the method can be operated in single-user mode or multi-user mode. The production of a report in multi-user mode will generally have the effect of reducing the time that is required for report production.

In an example embodiment, the cross-reference data, the object data and the medical reports can be held in a consistent manner. This advantageously contributes to a high standard of quality when producing medical reports, since the doctor can rely on a consistent pool of data for the report production, in which all cross-reference data cross-refers to object data that is actually available. In this case, the consistency of cross-reference data, object data and medical reports is ensured according to the following rules:

deletion of the cross-reference data deletes the associated object data in the medical reports;

if object data in the medical reports is deleted, this results in deletion of the cross-reference data;

deletion of the object data in turn deletes both the cross-reference data and the object data in the medical reports.

A further embodiment additionally allows a change history of the cross-reference data to be displayed. It is therefore possible to view all of the cross-reference data that was ever stored previously. This advantageously allows the subsequent reconstruction of activities related to findings.

At least one embodiment of the invention also is directed to an arrangement for producing medical reports. In this case, the arrangement comprises a navigation unit in which is stored the cross-reference data that cross-refers to object data obtained from a plurality of medical applications. The navigation unit (which can also be called the finding navigator) therefore represents the interface to the individual medical applications, which can be switched in as required, and stores the references to the object data in the medical applications. The arrangement further comprises a report generator unit (which can also be called the reporting task), by means of which the medical reports are produced. In the medical reports, the object data is accessed with the aid of its cross-reference data.

Furthermore, the arrangement can comprise a storage unit in which the object data is stored with the aid of its cross-reference data. It is therefore possible to store a graphic view of the finding directly in the medical data management system. This has the advantage of allowing faster access to the data objects with the aid of the cross-reference data.

In a further embodiment, the arrangement can comprise a display unit, on which the object data, the cross-reference data and the medical reports are displayed. The display unit provides the interface to one or more users. The display unit advantageously allows for example the storage of cross-reference data by one or more users.

In a further embodiment, the arrangement can be integrated in a system which comprises a process control unit for controlling a medical workflow, and a plurality of medical applications. Using the navigation unit, it is possible to switch to a plurality of medical applications whose object data is to be accessed during the production of the medical report. Furthermore, the system comprises a process control unit for controlling a medical workflow. By combining the individual system components in a computer network, it is possible to network the data resources. The cross-reference data that is stored in the navigation unit can therefore be integrated into the workflow routines that are controlled by the process control. The process control system, which interconnects the partial processes of the individual users to form an overall workflow, can therefore integrate the cross-reference data when configuring the individual processes. This has the advantage that the cross-reference data can be optimally incorporated into the partial processes of the individual users.

### BRIEF DESCRIPTION OF THE DRAWINGS

Further particularities and advantages of the invention are clarified by the following explanations relating to an example embodiment, and with reference to schematic drawings in which:

FIG. 1 shows a flow diagram of a method for producing medical reports,

FIG. 2 shows a block schematic diagram of an arrangement for producing medical reports,

FIG. 3 shows a section of a user interface of a navigation unit for displaying cross-reference data,

FIG. 4 shows a section of a user interface of a navigation unit and a plurality of medical applications,

FIG. 5 shows a section of a user interface for a navigation unit and a plurality of medical applications, including a display of stored object data,

FIG. 6 shows a flow diagram for establishing data consistency,

FIG. 7 shows a flow diagram for switching between a navigation unit and a medical application, and

FIG. 8 shows a block schematic diagram of a system for producing medical reports.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

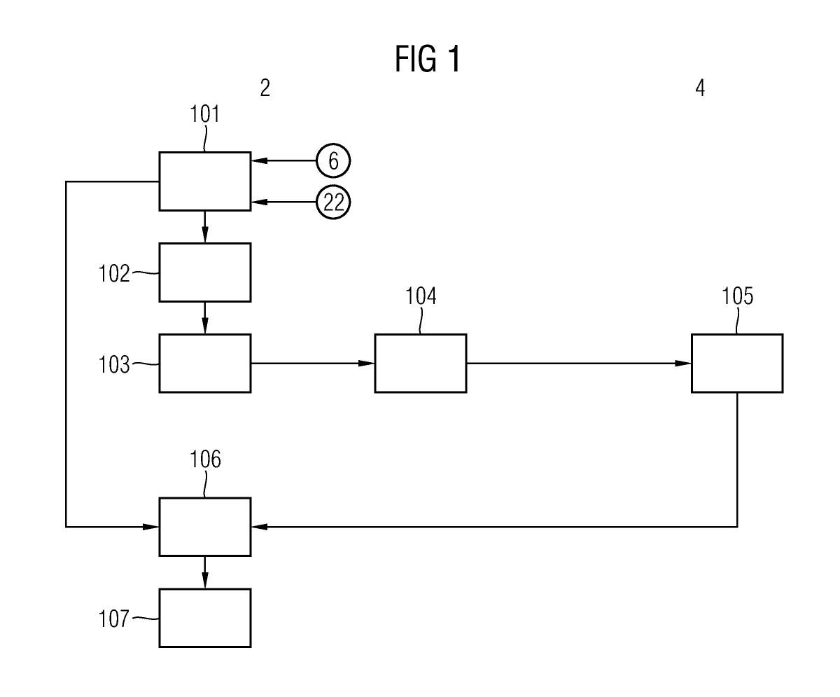

FIG. 1 represents a flow diagram of an inventive method for producing medical reports. In step 101, cross-reference data 22 to object data 6 that was obtained using medical applications is stored in a navigation unit 2. The storage of the cross-reference data 22 can be patient-oriented. In a subsequent step 102, e.g. the object data 6 belonging to the cross-reference data 22 can comprise graphic views, in order to allow rapid access to these views. In step 103, the cross-reference data 22 can be displayed and in step 104, the object data 6 can be displayed. In step 105, medical reports are produced in a report generator unit 4. In this case, object data 6 can be included in the reports via its cross-reference data 22. In step 106, cross-reference data 22, object data 6 and the medical reports are held in a consistent manner. In step 107, the change history of the cross-reference data 22 can be displayed.

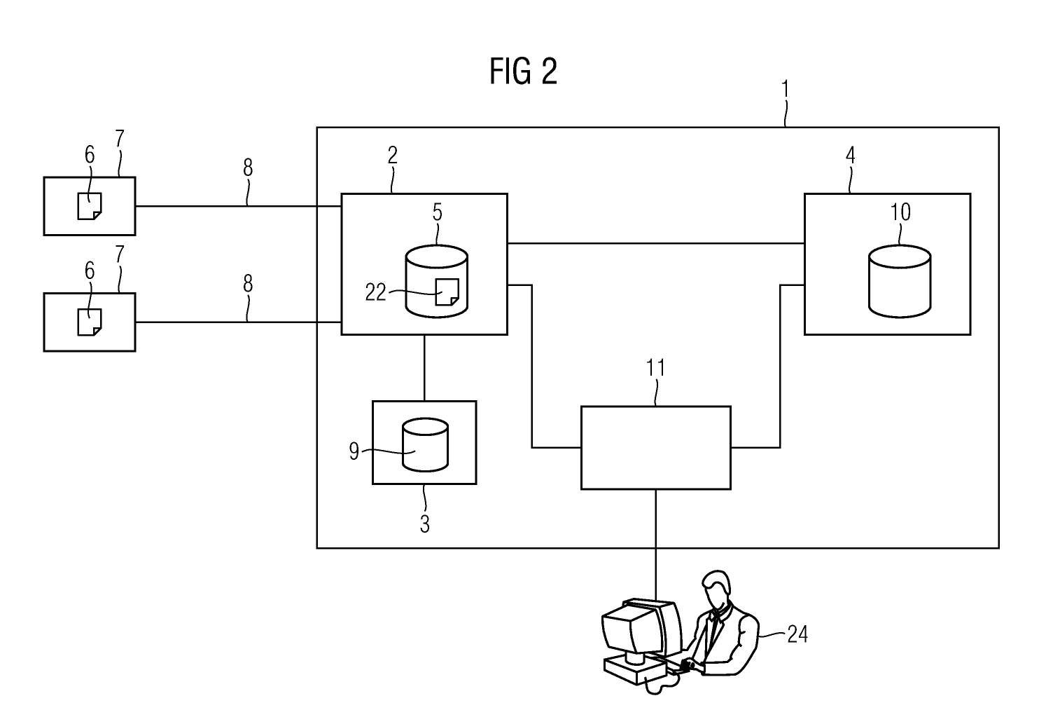

FIG. 2 shows a block schematic diagram of an arrangement featuring the essential components for producing medical reports. A medical data management system 1 comprises a navigation unit 2, a storage unit 3 and a report generator unit 4. The navigation unit 2 contains a cross-reference database 5 containing cross-reference data 22 to object data 6 that was obtained by means of medical applications 7. The medical applications 7 are connected to the navigation unit 2 via data interfaces 8. Connected to the navigation unit 2 is a storage unit 3 comprising an object database 9. E.g. graphic views 6 of the object data 6 are stored in the object database 9 with the aid of their cross-reference data. The production of the medical reports takes place in the report generator unit 4, which is likewise linked to the navigation unit 2. These are stored in a report database 10. The interface to one or more users 12 is established via a display unit 11. The display unit 11 is linked to the navigation unit 2 and to the report generator unit 4. Therefore the user can optionally access the object data 6 of the medical applications 7, the cross-reference data 22 of the cross-reference database 5, e.g. the snapshot images of the object data (these being stored in the object database 9), and the medical reports of the report database 10.

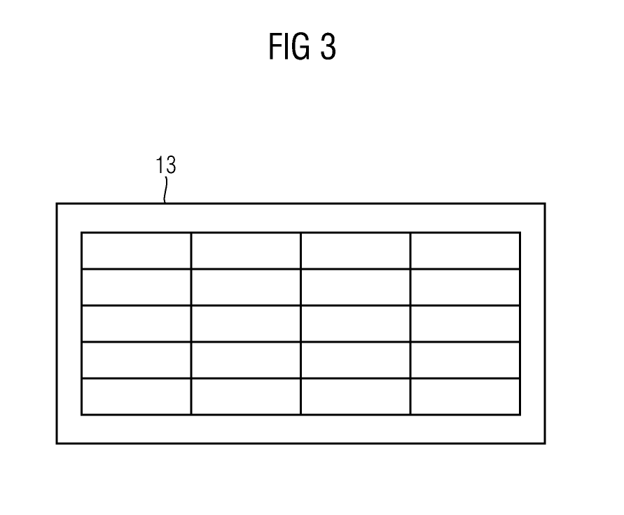

FIG. 3 shows a section of a user interface of the navigation unit for displaying cross-reference data. In the display window 13 for cross-reference data, the findings that are stored in the cross-reference database are listed by row in a table. The columns of the table can be used to specify a designation of the relevant finding and further details relating to the finding, e.g. quantitative details relating to the finding such as e.g. the length of a distance line. The medical applications from which the findings were obtained can additionally be specified in a further column.

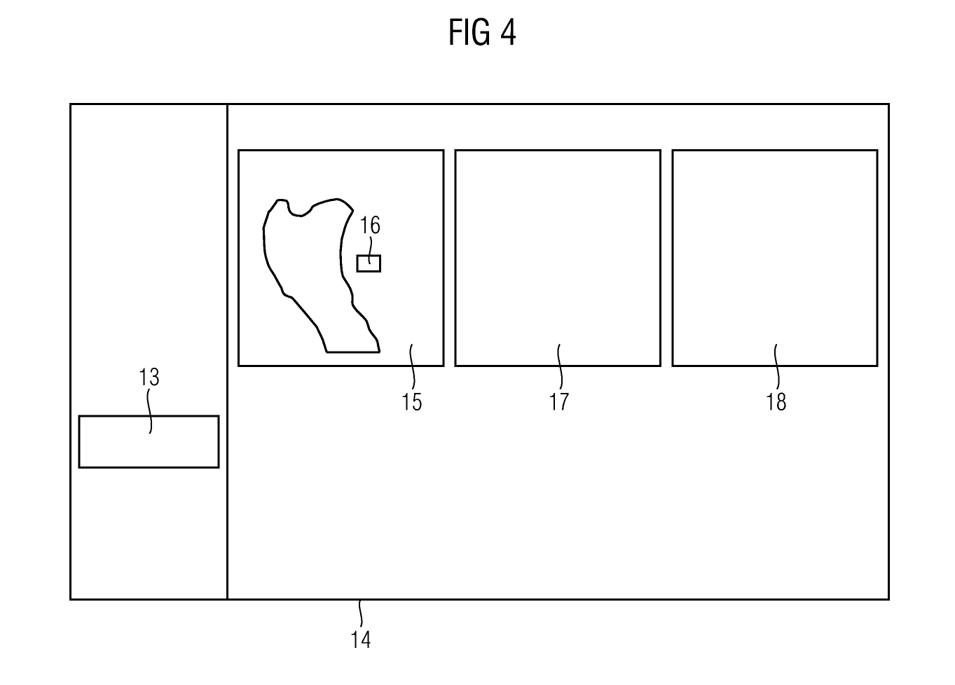

FIG. 4 shows a section of a user interface for a navigation unit and a plurality of medical applications.

A first medical application 15 is switched to active in the display window 14. A finding in the form of a distance line 16 has been generated. The finding 16 immediately appears in the display window 13 for cross-reference data. The finding 16 is likewise visible in a second medical application 17. If the user now switches actively into the second medical application 17, the display window 13 for cross-reference data and its contents remain visible. In the second medical application 17, the user can likewise produce findings that are visible in the display window 13 for cross-reference data. If a third medical application 18 is now activated, the user sees all of the defined findings of the medical applications 15, 17, 18 in the display window 13 for cross-reference data. After generation of a finding in a medical application, the user can continue working with the relevant application. For example, the user can switch layouts in the currently active medical application or use tools of the medical application. When a finding is selected in the display window 13 for cross-reference data, the medical application that produced the finding is automatically switched to active. In the medical application, the layout that was active during generation of the finding is switched to active. Within the layout, that image is selected on which the finding can be seen. By virtue of this functionality, it is easily possible to jump from application to application by selecting corresponding findings in the display window 13 for cross-reference data.

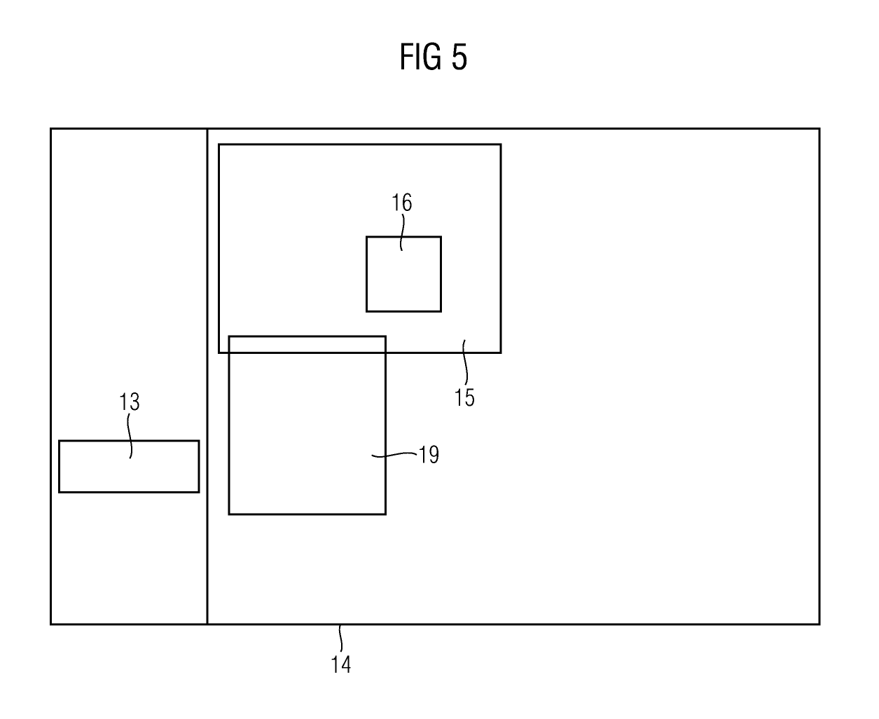

FIG. 5 shows a section of a user interface for a navigation unit and a plurality of medical applications displaying stored object data. In the display window 14, a finding in the form of a distance line 16 is contained in the display window of a first medical application 15. The finding 16 is visible in the display window 13 for cross-reference data. When the entry in the display window 13 for cross-reference data is selected, a graphic view 19 of the stored object data is displayed, said graphic view 19 being stored in the navigation unit 2. In most cases, this view will satisfy the needs of the doctor, and therefore it will be unnecessary to switch into the relevant medical application for the purpose of editing the finding 16.

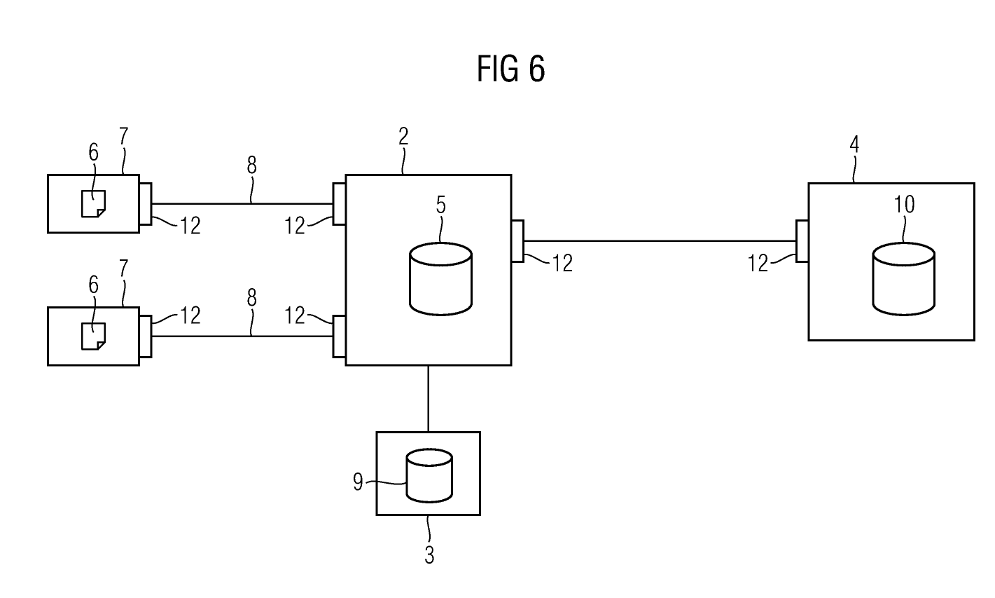

FIG. 6 shows a flow diagram for establishing the data consistency between cross-reference data, object data and medical reports. The two medical applications 7 that are represented, the navigation unit 2 and the report generator unit 4 are equipped with data ports 12 for this purpose. The data ports are used for the exchange of findings between the participating systems. Each participating system has at least one input and output port for receiving and sending findings. The following messages can be sent between the participating systems via the ports:

Notification_Clinical|Finding_Created

(creation of a finding),

Notification_Clinical|Finding_Modified

(modification of a finding),

Notification_Clinical|Finding_Deleted

(deletion of a finding),

Notification_Clinical|Finding_Selected

(selection of a finding).

Corresponding actions are triggered in the relevant systems on the basis of these messages. As a result of this so-called broadcasting model, which ensures that all participating systems receive and process the messages, consistency of the data is achieved. The broadcasting model also satisfies the requirement to link additional medical applications 7 to the navigation unit 2. It is also easily possible to link further report generator units 4 to the navigation unit.

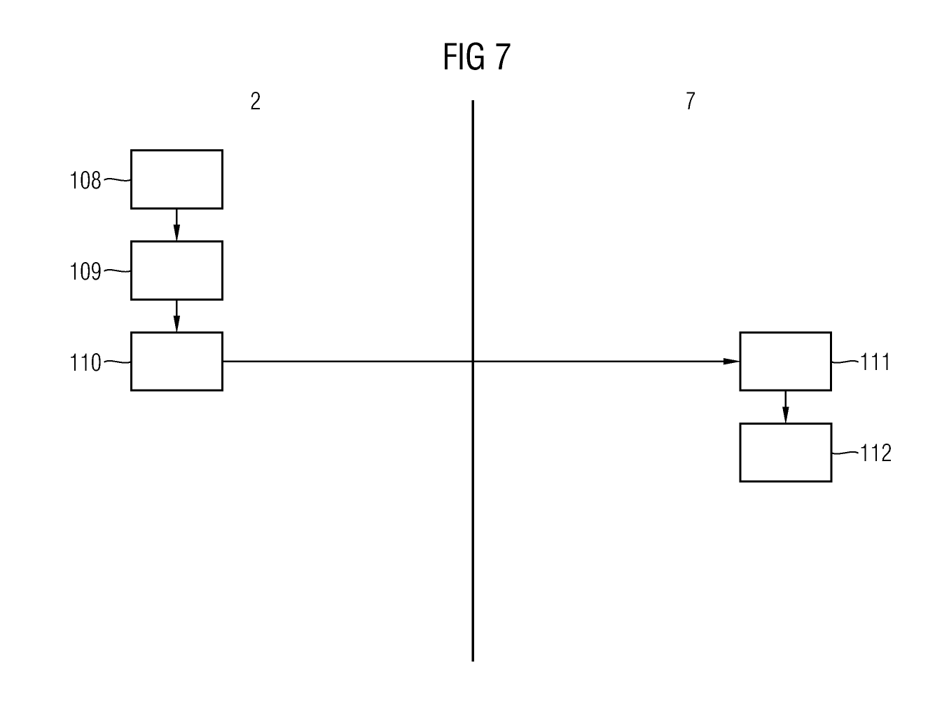

FIG. 7 shows a flow diagram for switching between a navigation unit and a medical application.

In a first step 108, a finding is selected in a navigation unit 2, wherein the finding is to be displayed in the originally generated form in the underlying medical application 7. In step 109, the medical application 7 from which the finding was obtained is determined in the data record that was created for the finding in the navigation unit. In step 110, a connection is set up to the medical application 7 thus determined. In step 111, the layout by which the finding was produced in the medical application 7 is made available in the medical application 7. In step 112, the finding is then displayed in the original layout.

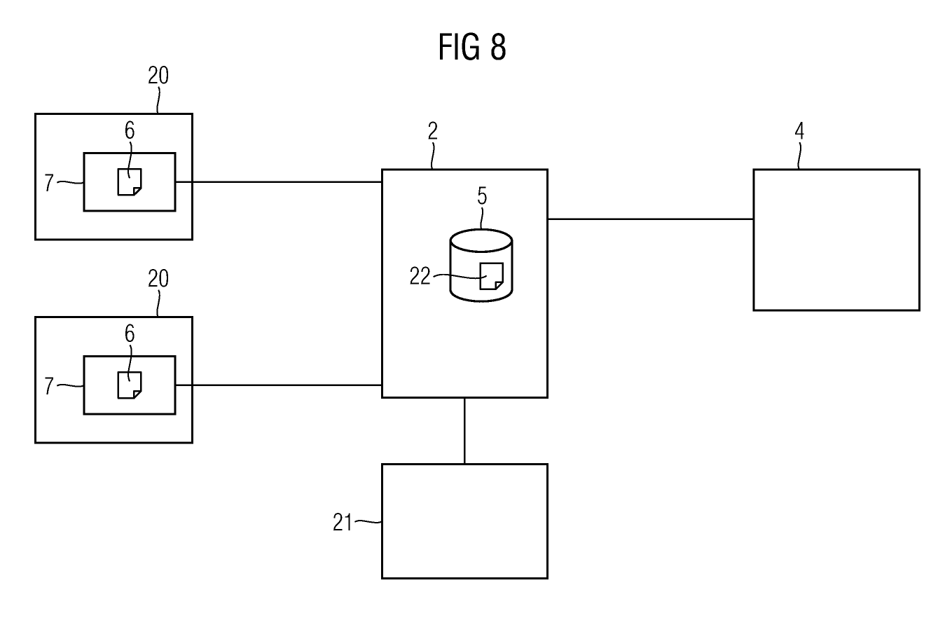

FIG. 8 shows a block schematic diagram of a system for producing medical reports. The system comprises a navigation unit (2) and a plurality of medical devices 20, on which the medical applications 7 are executed. The navigation unit 2 contains a cross-reference database 5, in which is contained cross-reference data 22 relating to object data 6 that was obtained using medical applications 7. The system further comprises a process control unit 21, which controls a medical workflow. The process control unit (21) is connected to the navigation unit 2. The navigation unit 2 contains a cross-reference database 5, in which are contained cross-references to object data 6 that was obtained using the medical applications 7. Also linked to the navigation unit 2 is a report generator unit 4. By combining the individual system components, it is possible to network the data resources. The cross-reference data 22 that is stored in the navigation unit 2 can therefore be integrated into the workflow routines that are controlled by the process control unit 21. The process control unit 21, which interconnects the partial processes of the individual users to form an overall workflow, can therefore integrate the cross-reference data when configuring the individual processes.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, non-transitory computer readable medium and non-transitory computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a non-transitory computer readable medium and is adapted to perform any one of the aforementioned methods when run on a computer device (a device including a processor). Thus, the non-transitory storage medium or non-transitory computer readable medium, is adapted to store information and is adapted to interact with a data processing facility or computer device to execute the program of any of the above mentioned embodiments and/or to perform the method of any of the above mentioned embodiments.

The non-transitory computer readable medium or non-transitory storage medium may be a built-in medium installed inside a computer device main body or a removable non-transitory medium arranged so that it can be separated from the computer device main body. Examples of the built-in non-transitory medium include, but are not limited to, rewriteable non-volatile memories, such as ROMs and flash memories, and hard disks. Examples of the removable non-transitory medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### LIST OF REFERENCE SIGNS

1 Medical data management system
2 Navigation unit
3 Storage unit
4 Report generator unit
5 Cross-reference database
6 Object data
7 Medical applications
8 Data interfaces: medical applications/navigation unit
9 Object database
10 Report database
11 Display unit
12 Data port
13 Display window for cross-reference data
14 Display window for navigation unit and medical applications
15 First medical application
16 Distance line
17 Second medical application
18 Third medical application
19 View of the stored object data
20 Medical devices
21 Process control unit
22 Cross-reference data
23 Object data
101 Store cross-reference data relating to object data
102 Store object data
103 Display cross-reference data
104 Display object data
105 Produce medical reports
106 Hold data consistently
107 Display change history for cross-reference data
108 Select a finding
109 Determine medical application
110 Set up connection to medical application
111 Make layout available
112 Display finding in the original layout

What is claimed is:

1. A method for producing medical reports, said method being performed in a medical data management system, the method comprising:
storing cross-reference data which cross-refers to object data that is obtained from a plurality of medical applications; and
producing medical reports featuring the object data using the medical data management system, wherein the object data is accessed with the aid of its cross-reference data.

2. The method as claimed in claim 1, further comprising:
storing the object data in the medical data management system with the aid of the cross-reference data.

3. The method as claimed in claim 2, further comprising:
displaying the object data before producing the medical reports.

4. The method as claimed in claim 1, further comprising:
displaying the object data with the aid of its cross-reference data before producing the medical reports.

5. The method as claimed in claim 1, further comprising:
storing the cross-reference data in a patient-oriented manner.

6. The method as claimed in claim 1, further comprising:
accessing of the cross-reference data by a plurality of users, simultaneously or at different times.

7. The method as claimed in claim 1, further comprising:
holding the cross-reference data, the object data and the medical reports in a consistent manner in accordance with the following rules:
deletion of the cross-reference data deletes the associated object data in the medical reports;
deletion of the object data in the medical reports deletes the cross-reference data; and
deletion of the object data deletes the cross-reference data and the object data in the medical reports.

8. The method as claimed in claim 7, further comprising:
displaying a change history of the cross-reference data.

9. An arrangement for producing medical reports, comprising:
a navigation unit to store cross-reference data that cross-refers to object data obtained from a plurality of medical applications; and
a report generator unit to produce medical reports, wherein the object data is accessed with the aid of its cross-reference data.

10. The arrangement as claimed in claim 9, further comprising:
a storage unit to store the object data with the aid of the cross-reference data.

11. The arrangement as claimed in claim 9, further comprising:
a display unit to display at least one of the object data, the cross-reference data and the medical reports.

12. A system comprising an arrangement as claimed in claim 9, further comprising:
a process control unit to control a medical workflow; and
medical devices to execute the medical applications, wherein the medical devices exchange the cross-reference data with the navigation unit and with each other.

13. The method as claimed in claim 1, further comprising:
storing the cross-reference data in a patient-oriented manner.

14. The arrangement as claimed in claim 10, further comprising:
a display unit to display at least one of the object data, the cross-reference data and the medical reports.

15. A system comprising an arrangement as claimed in claim 10, further comprising:
a process control unit to control a medical workflow; and
medical devices to execute the medical applications, wherein the medical devices exchange the cross-reference data with the navigation unit and with each other.

16. A system comprising an arrangement as claimed in claim 11, further comprising:
a process control unit to control a medical workflow; and
medical devices to execute the medical applications, wherein the medical devices exchange the cross-reference data with the navigation unit and with each other.

17. A system comprising an arrangement as claimed in claim 14, further comprising:
a process control unit to control a medical workflow; and
medical devices to execute the medical applications, wherein the medical devices exchange the cross-reference data with the navigation unit and with each other.

18. A non-transitory computer readable medium including program segments for, when executed on a computer device, causing the computer device to implement the method of claim 1.

19. The method of claim 1, wherein the storing is performed by a navigation unit and the producing is performed by a report generator unit.

20. The method of claim 3, wherein the displaying is performed by a display unit.

21. The method of claim 2, wherein the storing is performed by a navigation unit.

22. The method of claim 4, wherein the displaying is performed by a display unit.
